(19) United States
(12) Patent Application Publication
(10) Pub. No.: US 2011/0212316 A1
(43) Pub. Date: Sep. 1, 2011

(54) PROCESS FOR MAKING A UHMWPE-TAPE, WIDE SLIT EXTRUSION DIE AND A MANUFACTURED UHMWPE-TAPE THEREOF

(75) Inventors: Engelbertus Henricus Maria E.H.M. Gorp,Van, Beek (NL); Peter P. Dewit, Echt (NL); Guus G. Brouwers, Noorbeek (NL)

(73) Assignee: DSM IP ASSETS, B.V., Heerlen (NL)

(21) Appl. No.: 13/128,462

(22) PCT Filed: Nov. 30, 2009
(86) PCT No.: PCT/EP2009/066066

§ 371 Date: May 10, 2011

(30) Foreign Application Priority Data
Dec. 1, 2008 (EP) 08020839.0

(51) Int. Cl. B32B 3/00; B29C 69/00; B29C 47/00; B29C 47/14; B29B 7/00

(52) U.S. Cl. 428/220; 264/291; 425/380; 428/542.8

(57) ABSTRACT

A process for making a UHMWPE tape comprises providing a fluid composition comprising HMwPE and/or UHMwPE; extruding a fluid tape from the fluid composition from an extrusion die (100); cooling the fluid tape to obtain a solidified tape and drawing the solidified tape in at least one direction in at least one drawing step at a draw ratio of at least (3) in the machine direction. The extrusion die (100) comprises at least two die inlets (21, 22, 23) through which the fluid composition is supplied; an extrusion slit (80) through which the solution tape is extruded and a cavity (40) divided in the width direction of the extrusion slit into a plurality of cavity sections (41, 42, 43), each cavity section (41, 42, 43) connecting its corresponding die inlet (21, 22, 23) and the extrusion slit (80), wherein the plurality of cavity sections (41, 42, 43) are arranged such that the flow speed of the fluid composition in the cavity sections (41, 42, 43) at the extrusion slit is substantially equal between the cavity sections (41, 42, 43).

### TECHNICAL FIELD OF THE INVENTION

The invention relates to a process for making an ultrahigh molecular weight polyethylene (UHMwPE) tape and a tape obtainable by the process. The invention further relates to an extrusion die for use in a tape making process and an extrusion apparatus comprising such an extrusion die.

### BACKGROUND OF THE INVENTION

A UHMwPE tape is known from WO2007/122010. This publication discloses a process for preparing a UHMwPE tape by the gel-spinning process. The tape disclosed in the example in this publication has a width of 20 mm. In producing a tape with the gel-spinning technology, a considerable reduction of width of the tape takes place during the steps of drying and unidirectional drawing of the tape. The width reduction ratio depends considerably on the stretch ratio, but a tape having a final width of 20 mm would typically require an extrusion slit with a substantially larger width.

A tape is in general produced from a die which has a die inlet through which a fluid composition is supplied, an extrusion slit through which a solution tape is extruded and a cavity connecting the die inlet and the extrusion slit. Examples of extrusion dies are described in U.S. Pat. No. 7,056,112 and U.S. Pat. No. 5,494,429, which are incorporated herein by reference. A larger tape width requires a wider extrusion slit, and the shortest distance between the die inlet and the extrusion slit, i.e. generally the height of the die, is also increased. Increase of the height of the die is significantly disadvantageous from the cost point of view. The cavity may be constructed to adjust the flow of the fluid composition, such as by employing a so-called coat-hanger die shape, but the construction becomes more complex and it becomes increasingly difficult to make precise adjustments to a die with a large width. Moreover, the tape is in general more sensitive to irregular flow of the fluid composition with a larger die, which leads to inhomogeneities in the tape thickness over the width and the length of the tape.

### OBJECT OF THE INVENTION

It is an object of the present invention to provide an improved process for making a UHMwPE tape. The improvement may for example be to overcome one or more of the above limitations.

### DISCLOSURE OF THE INVENTION

Therefore, a process for making a UHMWPE tape is provided, comprising:

providing a fluid composition comprising HMwPE and/or UHMwPE;

extruding a fluid tape from the fluid composition from an extrusion die;

cooling the fluid tape to obtain a solidified tape and

drawing the solidified tape in at least one direction in at least one drawing step at a

draw ratio of at least 3 in the machine direction,

wherein the extrusion die comprises
at least two die inlets through which the fluid composition is supplied;
an extrusion slit through which the solution tape is extruded and
a cavity divided in the width direction of the extrusion slit into a plurality of cavity sections, each cavity section connecting its corresponding die inlet and the extrusion slit, wherein the plurality of cavity sections are arranged such that the flow speed of the fluid composition in the cavity sections at the extrusion slit is substantially equal between the cavity sections.

In this process, an extrusion die comprising at least two die inlets is used. The cavity is divided into cavity sections in the width direction of the extrusion slit. As used herein, the width direction of the extrusion slit means the longer axis of the slit, i.e. the length direction of the die lips which constitute the extrusion slit. The distance between the die lips is referred as the gap length. The cavity sections are defined in the direction of the width of the extrusion slit by the side wall of the die or boundaries with other cavity sections. The boundaries may be virtual boundaries. The boundaries may also be real walls, as long as the walls do not extend to the extrusion slit. The division of the cavity is made in such a way that a virtual line having the shortest distance between the center of the die inlet and the extrusion slit is equally distanced from the two boundaries of the cavity section.

The flow speed of the fluid composition in each of these cavity sections at the extrusion slit is substantially equal between the cavity sections. The flow speed at the extrusion slit is defined herein as the volume of the fluid exiting the extrusion slit per unit area of the extrusion slit per unit time. The flow speed at the extrusion slit for each cavity section can be determined by measuring the volume of the fluid exiting the extrusion slit from respective cavity section. This equality of the fluid composition between the cavity sections has a surprising effect as explained below.

In an extrusion process using a conventional extrusion die, the speed of the flow is larger at the portion of the extrusion slit directly below the die inlet compared to the speed close to the side wall of the die. This difference in speed becomes larger as the width of the extrusion slit gets larger. A wide die having only one die inlet thus produces a flow with a wide variation in the flow speed and thus a tape with a highly inhomogeneous thickness. In comparison, in an extrusion die having the same width but comprising more than one die inlets, the flow speed variation is smaller. This results in that the extrusion speed becomes more homogeneous over the width of the extrusion slit compared to a die having the same width with only one die inlet. This homogeneity in the extrusion speed results in a homogeneous thickness and orientation of the PE in the tape. Thus, a tape obtained by this process has an improved homogeneous structure over its width.

A tape is herein understood to mean a flat elongated body, and includes a body which can be referred as a ribbon, a film or a sheet. The term ‘tape’ includes a body the length dimension (machine direction) of which is much greater than its cross section dimension, as well as a body which does not necessarily have a larger length dimension (machine direction) compared to the longer axis of the cross section. The cross section may have various anisotropic shapes, such as rectangular or elliptical. The longer axis of the cross section is referred as width and the shorter axis of the same, perpendicular to the width direction, is referred as thickness. The width direction of the tape corresponds to the width direction of the extrusion slit and the thickness direction of the tape corresponds to the gap length direction of the extrusion slit.

By high molecular weight polyethylene (HMwPE), it is herein meant a polyethylene with a molecular weight from 50,000 to 400,000. Ultrahigh molecular weight polyethylene (UHMwPE) is defined herein as a polyethylene with a molecular weight of at least 400,000. UHMwPE may have a molecular weight of up to several millions.

Intrinsic viscosity may be used for determining the molecular weight. Intrinsic viscosity is a measure for molar mass (also called molecular weight) that can more easily be determined than actual molar mass parameters such as Mn and Mw. The IV is determined according to method PTC-179 (Hercules Inc. Rev. Apr. 29, 1982) at 135° C. in decalin, the dissolution time being 16 hours, with DBPC as the anti-oxidant in an amount of 2 g/l solution, and the viscosity at different concentrations is extrapolated to zero concentration. There are several empirical relations between IV and Mw, but such relation is highly dependent on molar mass distribution. Based on the equation Mw=5.37*10⁴ [IV]^{1.37} (see EP 0504954 A1) an IV of 4.5 dl/g would be equivalent to a Mw of about 422 kg/mol.

Because of their long molecule chains, stretched UHMwPE fibers with an IV of more than 5 dl/g have very good mechanical properties, such as a high tensile strength, modulus, and energy absorption at break. More preferably, a polyethylene with an IV of more than 10 dl/g is chosen. This is because a yarn made by gel-spinning such UHMwPE offers a combination of high strength, low relative density, good hydrolysis resistance, and excellent wear properties. Suitable UHMwPE has an intrinsic viscosity of typically above 5 dl/g, preferably between about 8 and 40 dl/g, more preferably between 10 and 30, or 12 and 28, or between 15 and 25 dl/g.

Preferably, the HMwPE and UHMwPE of the present invention are a linear polyethylene, i.e. a polyethylene with less than one side chain or branch per 100 carbon atoms, and preferably less than one side chain per 300 carbon atoms, a branch generally containing at least 10 carbon atoms. Preferably, only polyethylene is present, but alternatively the polyethylene may further contain up to 5 mol % of alkenes that may or may not be copolymerized with it, such as propylene, butene, pentene, 4-methylpentene or octene. The polyethylene may further contain additives that are customary for such fibres, such as anti-oxidants, thermal stabilizers, colorants, etc., up to 15 weight %, preferably 1-10 weight %.

Each cavity section may be adjusted to obtain a homogeneous flow within each of the cavity sections. For example, each of the cavity sections may have the general shape of the cavity of an extrusion die generally referred as a coat hanger die. This allows that the flow in each of the cavity sections is homogeneous. The specific shape of the cavity section may be further adjusted to obtain an optimum result. The adjustment largely depends on the shortest distance between the die inlet and the extrusion slit. In an embodiment where the shortest distance between each of the die inlets and the extrusion slit is substantially the same, it is easier to apply the result of the adjustment made to one cavity section to other cavity sections.

Preferably, the cavity sections have substantially the same shape. The manufacturing process of such an extrusion die is easy.

Preferably, the speed of the fluid composition supplied to each of the die inlets is substantially the same. This allows the flow from the extrusion slit to be homogeneous in the cases where the flow in each of the cavity sections is substantially the same between each other. The speed of the supplying of the fluid composition is preferably controlled independently from each other for each die inlet by respective control means, such as a metering pump. Alternatively, the fluid composition to each of the die inlets is supplied from one chamber containing the fluid composition to be extruded. In this case, the fluid composition flows into the die inlets under influence of the same pressure in the chamber.

Preferably, the extrusion slit has an aspect ratio of at least 20, more preferably at least 40, even more preferably at least 75, even more preferably at least 100. The aspect ratio is a ratio between the width and the gap length. This allows manufacturing of a wide tape. In embodiments where the gap length varies along the width direction of the extrusion slit, the aspect ratio is determined with respect to the largest gap length.

The drawing may be done unidirectionally in the machine direction. In this case, the draw ratio is preferably at least 10, preferably at least 20, more preferably at least 50. Such high level of unidirectional drawing imparts a high tenacity in the longitudinal direction of the tape.

Alternatively, the drawing may also be done bidirectionally, i.e. in the machine direction as well as in the substantially traverse direction, or even in more directions. Preferably, the drawing is made at an area draw ratio, i.e. the stretch factor in terms of area, of at least 10. Drawing in more than one direction generally results in a porous tape. A porous tape, especially a porous tape made of UHMwPE, has a wide range of applications known in the art, such as a filtration membrane and a battery separator

The method of unidirectional and bidirectional drawing is well-known in the art and is not described here in detail.

According to a preferred embodiment, the tape is a gel-spun UHMwPE tape. Gel spinning of UHMwPE has been described in various publications, including EP 0205960 A, EP 0213208A1, U.S. Pat. No. 4,413,110, WO 01/73173 A1, and Advanced Fiber Spinning Technology, Ed. T. Nakajima, Woodhead Publ. Ltd (1994), ISBN 1-855-73182-7, and references cited therein. These publications are incorporated herein by reference. Therefore, according to one aspect of the present invention, the fluid composition is a solution of UHMwPE in a solvent and the process comprises the step of at least partly removing the solvent.

In the process, any of the known solvents for gel spinning of UHMwPE can be used. Suitable examples of spinning solvents include aliphatic and alicyclic hydrocarbons, e.g. octane, nonane, decane and paraffins, including isomers thereof; petroleum fractions; mineral oil; kerosene; aromatic hydrocarbons, e.g. toluene, xylene, and naphthalene, including hydrogenated derivatives thereof, e.g. decalin and tetralin; halogenated hydrocarbons, e.g. monochlorobenzene; and cycloalkanes or cycloalkenes, e.g. careen, fluorine, camphene, menthane, dipentene, naphthalene, acenaphtalene, methylcyclopentandien, tricyclodecane, 1,2,4,5-tetramethyl-1,4-cyclohexadiene, fluorenone, naphtindane, tetramethyl-p-benzodiquinone, ethylfuorene, fluoranthene and naphthenone. Also combinations of the above-enumerated spinning solvents may be used for gel spinning of UHMWPE, the combination of solvents being also referred to for simplicity as spinning solvent. In one embodiment, the spinning solvent of choice has a low vapor pressure at room temperature, e.g. paraffin oil. It was also found that the process of the invention is especially advantageous for relatively volatile spinning solvents at room temperature, as for example decalin, tetralin and kerosene grades. Most preferably, the spinning solvent is decalin.

A gel-spun UHMwPE tape made by unidirectional drawing has a very high tenacity. Preferably, the UHMwPE tape has a tenacity of at least 20 cN/dtex, preferably at least 25 cN/dtex, even more preferably at least 30 cN/dtex, most preferably at least 35 cN/dtex. Such a high tenacity is obtainable due to the fact that the tape is a drawn UHMwPE tape.

Furthermore, the gel-spun UHMwPE tape has a very high modulus. Preferably, the tape has a modulus of at least 600 cN/dtex, more preferably at least 900 cN/dtex, even more preferably at least 1300 cN/dtex.

According to a further embodiment, the tape is a melt-spun monofilament HMwPE tape or a melt-spun monofilament UHMwPE tape wherein the UHMwPE has a molecular weight of up to 800,000. The melt-spinning process is widely known in the art, and involves heating a PE composition to form a PE melt, extruding the PE melt, cooling the extruded melt so that the melt solidifies, and drawing the solidified PE at least once. The process is mentioned e.g. in EP0344860A1, WO03/037590A1 and EP1743659A1, which are incorporated herein by reference. Therefore, according to one aspect of the present invention, the fluid composition is a melt of a HMwPE and/or a UHMwPE having a molecular weight of up to 800,000.

In this embodiment, PE is chosen in view of the processibility. HMwPE can be melt-spun without difficulty, and UHMwPE with a molecular weight of up to 800,000 can also be melt-spun. A higher molecular weight provides a tape with more desirable mechanical properties, but processibility is decreased, and especially extruding becomes more difficult. Preferably the melt spun tape has a tenacity of at least 13 cN/dtex, preferably at least 16 cN/dtex, even more preferably at least 20 cN/dtex.

The present invention also relates to the tape obtainable by the process according to the present invention. Preferably, the tape has a width of at least 30 mm, more preferably at least 50 mm, even more preferably at least 100 mm. The tape according to the present invention has various applications, such as ballistic resistant articles, or applications for use in cut resistance, abrasion resistance and stab resistance. When the tapes are used in applications where the tapes are aligned next to each other as in the case of a ballistic resistant article, wider tapes are advantageous in that they require less number of steps of laying the tapes. Furthermore, wider tapes result in less number of boundaries between the tapes.

The present invention also relates to an extrusion die comprising at least two die inlets, an extrusion slit and a cavity divided in the width direction of the extrusion slit into cavity sections, each cavity section connecting its corresponding die inlet and the extrusion slit. The cavity section is defined in the same way as described above in relation to the process according to the present invention.

The present invention further relates to an extrusion apparatus comprising the extrusion die of the present invention and control means for controlling the speed of a fluid composition supplied to each of the die inlets during use. Preferably, the control means is a metering pump, but other options, for example as discussed elsewhere in the present description, are also feasible.

The present invention is further explained below with references to drawings in which:

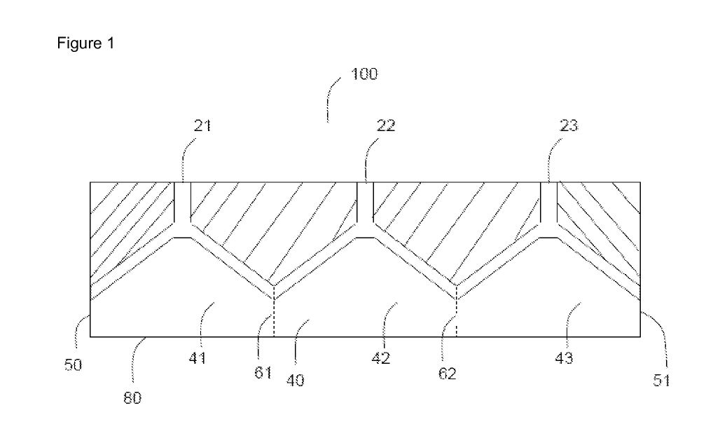

FIG. 1 schematically shows a cross section of an embodiment of the extrusion die according to the present invention;

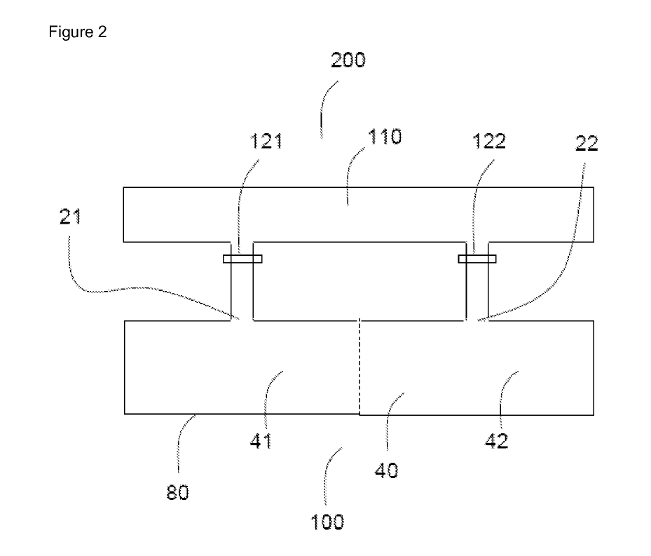

FIG. 2 schematically shows a cross section of an embodiment of an extrusion apparatus according to the present invention and

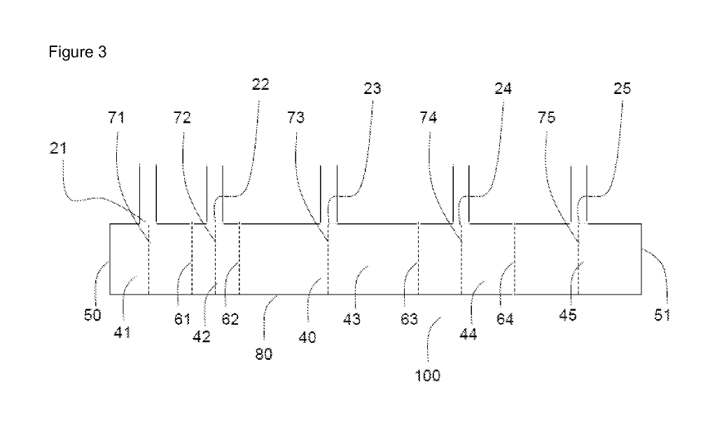

FIG. 3 schematically shows a cross section of a further embodiment of the extrusion die according to the present invention;

The figures are schematically drawn and not necessarily to size. Similar elements have been referred with the same reference numbers in the drawings.

Referring to FIG. 1, an extrusion die 100 is shown comprising a plurality of die inlets 21, 22, 23, an extrusion slit 80 and a cavity 40. The width of the extrusion slit 80 is defined by side walls 50,51. Each of the die inlets 21, 22, 23 is connected to a corresponding cavity section 41, 42, 43 which together form the cavity 40. The cavity sections 41, 42, 43 are divided by boundaries 61, 62. Each of the cavity sections 41, 42, 43 is arranged so as to spread a fluid composition and lead the fluid composition to a common extrusion slit 80. In this figure, each of the cavity sections 41, 42, 43 has the general shape of a coat hanger, i.e., each of the cavity sections 41, 42, 43 has the general shape of the cavity of an extrusion die generally referred as a coat hanger die. It will be appreciated that the cavity sections may also have different shapes, such as the shape of the cavity of a T-die or a fish tail die. The respective distance between the extrusion slit 80 and the die inlets 21,22,23 is substantially the same. The cavity sections 41,43,43 have essentially the same shape.

Referring to FIG. 2, an extrusion apparatus 200 is shown comprising an extrusion die 100 and a supply chamber 110. The supply chamber 110 is connected to die inlets 21,22 of the extrusion die 100 via metering pumps 121,122. During use, the metering pumps 121,122 may be used to control the individual flow to the die inlets 21,22, thereby adjusting the flow in each cavity sections so that homogeneous tape thickness is obtained. A feedback mechanism may be used which measures the flow speed at the extrusion slit 80 to control the speed of the supply to the die inlets 21,22.

In FIG. 3, another embodiment of the extrusion die 100 of the present invention is shown comprising a cavity 40 and an extrusion slit 80 the width of which is defined by two side walls 50 and 51, as in FIG. 1. The extrusion die 100 has five die inlets 21-25, and five corresponding cavity sections 41-45 which together make up a cavity 40. The cavity sections 41-45 are divided by virtual boundaries 61-64. Broken lines having the shortest distance from the center of each of the die inlets 21-25 and the extrusion slit 80 are shown as 71-75. The boundary 61 is located such that the virtual line 71 is equally distanced from the side wall 50 and the boundary 61. Similarly, the virtual line 72 is equally distanced from the boundary 61 and the boundary 62. Analogical relationship holds for the rest of the virtual lines 73-75 with respect to the distance from the two boundaries of the cavity sections. The cavity sections 41-45 do not have the same shape or volume in this embodiment. In this case, the supply of the fluid composition to the die inlets 21-25 and/or the shape of each cavity sections 41-45 may be respectively adjusted to obtain the same flow speed at the extrusion slit 80 between the cavity sections 41-45.

Various modifications to the extrusion die and the extrusion apparatus will be apparent to the skilled person. For example, the number of the die inlets is not limited, as long as it is at least two. The die inlets do not have to be equally distanced from the extrusion slit. Some or all of the die inlets may be arranged not only on the side of the extrusion die facing the extrusion slit (top wall of the die), but also at different sides such as on the die walls along the width direction of the extrusion slit. The metering pumps may not be necessary depending on the shape of the supply chamber and the shape of the cavity.

1. A process for making a UHMWPE tape, comprising:
providing a fluid composition comprising HMwPE and/or UHMwPE;
extruding a fluid tape from the fluid composition from an extrusion die (100);
cooling the fluid tape to obtain a solidified tape and
drawing the solidified tape in at least one direction in at least one drawing step at a draw ratio of at least 3 in the machine direction,
wherein the extrusion die (100) comprises
at least two die inlets (21, 22, 23, 24, 25) through which the fluid composition is supplied;
an extrusion slit (80) through which the solution tape is extruded and
a cavity (40) divided in the width direction of the extrusion slit into a plurality of cavity sections (41, 42, 43, 44, 45), each cavity section (41, 42, 43, 44, 45) connecting its corresponding die inlet (21, 22, 23, 24, 25) and the extrusion slit (80), wherein the plurality of cavity sections (41, 42, 43, 44, 45) are arranged such that the flow speed of the fluid composition in the cavity sections (41, 42, 43, 44, 45) at the extrusion slit is substantially equal between the cavity sections (41, 42, 43, 44, 45).

2. The process according to claim 1, wherein the shortest distance between each of the die inlets (21, 22, 23, 24, 25) and the extrusion slit (80) is substantially the same.

3. The process according to claim 1, wherein the cavity sections (41, 42, 43, 44, 45) have substantially the same shape.

4. The process according to claim 1, wherein each of the cavity sections (41, 42, 43, 44, 45) has a coat hanger die shape.

5. The process according to claim 1, wherein the speed of fluid composition supplied to each of the die inlets (21, 22, 23, 24, 25) is substantially the same.

6. The process according to claim 1,
wherein the extrusion slit (80) has an aspect ratio of at least 20, more preferably at least 40, even more preferably at least 75, even more preferably at least 100.

7. The process according to claim 1,
wherein the drawing is performed only in the machine direction, and at a draw ratio of at least 3, preferably at least 10, more preferably at least 20, even more preferably at least 50.

8. The process according to claim 1, wherein the drawing is performed in at least two directions, and at an area draw ratio of at least 10.

9. The process according to claim 1, wherein the fluid composition is a solution of UHMwPE in a solvent and the process comprises the step of at least partly removing the solvent.

10. The process according to claim 1, wherein the fluid composition is a melt of a HMwPE and/or a UHMwPE having a molecular weight of up to 800,000.

11. A tape obtainable by the process according to claim 1.

12. The tape according to claim 11, wherein the tape has a width of at least 30 mm, more preferably at least 50 mm, even more preferably at least 100 mm.

13. An extrusion die (100) comprising at least two die inlets (21, 22, 23, 24, 25), an extrusion slit (80) and a cavity (40) divided in the length direction of the extrusion slit into cavity sections (41, 42, 43, 44, 45), each cavity section (41, 42, 43, 44, 45) connecting its corresponding die inlet (21, 22, 23, 24, 25) and the extrusion slit (80).

14. An extrusion apparatus comprising the extrusion die according to claim 13 and control means (121,122) for controlling the speed of a fluid composition supplied to each of the die inlets (21, 22) during use.

15. An extrusion apparatus as claimed in claim 14, wherein the control means (121,122) is a metering pump.
